(19) United States
(12) Patent Application Publication
(10) Pub. No.: US 2008/0312964 A1
(43) Pub. Date: Dec. 18, 2008

(54) System and Method for Electronic Home Health Care

(75) Inventors: Gary Smith, Kitchener (CA); David McLean, Guelph (CA); Mike Skeen, Kitchener (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: MEDSHARE INC., Cambridge (CA)

(21) Appl. No.: 11/762,301

(22) Filed: Jun. 13, 2007

(51) Int. Cl. G06Q 50/00

(52) U.S. Cl. 705/3

(57) ABSTRACT

The present invention relates to a system and method for managing the business of providing home health care. It facilitates the matching of a health care worker to a client based upon the attributes the health care worker possesses and how those attributes match the needs of a client. In addition there is provided a component for the creation and generation of smart forms which allow the health care worker to enter and track information on visits to a client via a computing device. The completed forms then being accessible for billing and data mining.

### BACKGROUND OF THE INVENTION

In dealing with home health care, providers of such a service have to deal with a number of issues. Examples being:
a) Filing and tracking an Electronic Health Record (EHR) for a client and keeping that record secure;
b) Determining a suitable match between a health care worker or a point of care worker (hereinafter both generically referred to as a HCW) and the client;
c) Scheduling home care visits; and
d) Receiving and recording reports from visits made by a HCW.
   Traditionally such issues have been addressed by a number of systems, be they electronic or manual. Traditional systems for home health care are largely paper based as information is passed via FAX or handwritten reports. This is inefficient due to the paper records to be maintained as well as the time required to ensure that all information regarding a client is accurately recorded.

Thus there is a need for a home health care system that addresses these issues in a user friendly, timely and efficient manner.

### SUMMARY OF THE INVENTION

The e present invention is directed to a system for managing the assignment of and the reporting of health care workers, comprising:

a module configured to create and edit health care worker attributes;

a module configured to create and edit a health care worker profile based on the attributes;

a module configured to assign a health care worker to a client based upon the profile; and

a smart forms module configured to create forms for electronic presentation to the health care worker to record information on a client visit.

The present invention is also directed to a method for managing the assignment of and the reporting of health care workers, comprising the steps of:

creating health care worker attributes;

creating a health care worker profile based on the attributes;

assigning a health care worker to a client based on said profile; and

electronically providing smart forms to the health care worker to record information on a client visit.

### BRIEF DESCRIPTION OF THE DRAWINGS

For a better understanding of the present invention, and to show more clearly how it may be carried into effect, reference will now be made, by way of example, to the accompanying drawings which aid in understanding an embodiment of the present invention and in which:

FIG. 1 is a block diagram of a system utilizing an embodiment of the present invention;

FIG. 2 is a block diagram of the components of an embodiment of the present invention;

FIG. 3 is a flow chart of the process for assigning a health care working to a client;

FIG. 4 is a block diagram of the components of the system implementing smart forms;

FIG. 5 is a flowchart of the process for creating or editing a smart form;

FIG. 6 is a flowchart of the process for a subscriber entering data for a smart form;

FIG. 7 is a flowchart of the steps preformed by the rendering engine; and

FIG. 8 is a flowchart of the steps of data validation.

### DETAILED DESCRIPTION OF EMBODIMENTS OF THE INVENTION

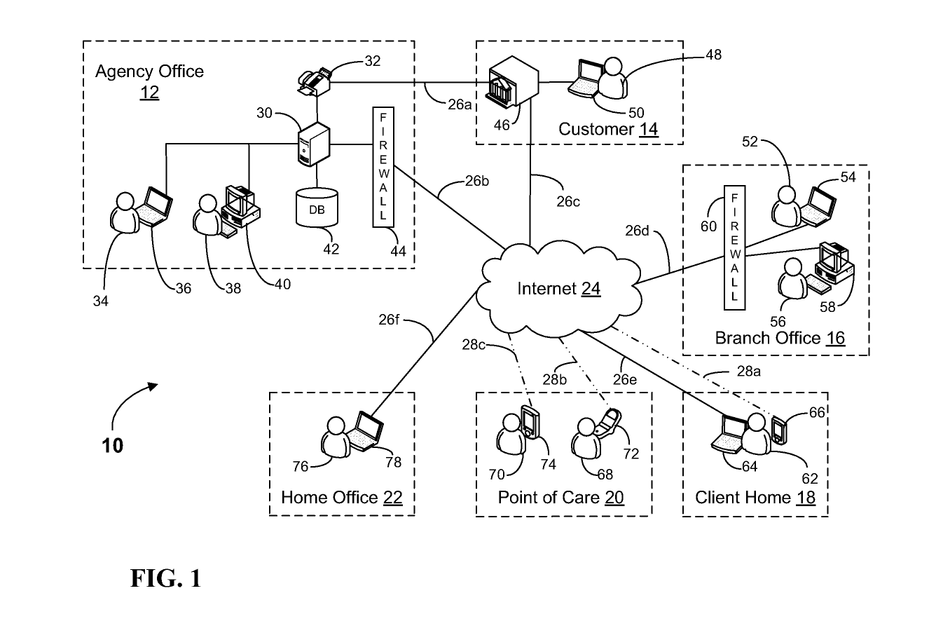

Referring now to FIG. 1, a block diagram of a system utilizing an embodiment of the present invention is shown generally as 10. System 10 comprises an agency office 12, a customer 14, a branch office 16, a client home 18, a point of care 20 and a home office 22. Each of components 12, 14, 16, 18, 20 and 22 (hereinafter referred to as 12 to 22) are connected to the Internet 24. Internet 24 is meant to serve only as an example. Any communication network allowing components 12 to 22 to communicate may be substituted for Internet 24. Each component 12 to 22 communicates with Internet 24 via either a wired link 26a, 26b, 26c, 26d, 26e or 26f (shown by a solid line) or a wireless link 28a, 28b or 28c (shown by a dashed line). As one skilled in the art can appreciate any of these links may be wired or wireless, the links shown in FIG. 1 illustrate an example of connections that may be utilized.

Agency office 12 is a company that is in the business of providing health care workers. Agency office 12 comprises a server 30, which is connected to the internet 24 via a firewall 44. Server 30 is shown as a single server for simplicity but in reality may comprise multiple servers. Server 30 is connected to a FAX 32 or other communication device to receive customer services orders from customer 14 via link 26a. FAX 32 is shown as it is a common device for receiving customer service orders, however any other device such as email or voicemail may be employed. Management 34, through the use of a computing device 36 may access server 30 to obtain reporting information on data stored by the system sever 30. Administration staff 38, through the use of computing device 40 may access server 30 to enter information such as: payroll, billing, scheduling and adding new clients to the system. Database 42 contains information such as:
a) The Electronic Health Care Record (EHR) of the client;
b) Information that is client specific on needs and desires;
c) Names, contact information and schedules for HCW's;
d) Information that is specific to HCW's regarding needs and desires; and
e) Information on visits made by HCW's for the purpose of tracking visits and creating billing and reports on those visits.
   As one skilled in the art can appreciate database 42 may take any form and may be distributed across multiple devices. The above description is meant to indicate the type of data that may be stored in database 42 for use by the system.

Firewall 44 provides secure communication between server 30 and Internet 24 through link 26b.

Customer 14 comprises a customer site 46, and a computer system 50 which is accessed by a case manager 48. Customer site 46 is the system that the customer uses to manage their own systems. It is shown only for illustrative means to indicate a connection between a customer 14 and agency office 12. Case manager 48 is the person who is responsible for a client customer service order sent to agency office 12 and the main contact for the agency office on matters regarding the client. For example should a HCW suggest more visits for a client the HCW would consult with the case manager 48. Customer site 46 communicates with the Internet via link 26c.

Branch office 16 is a branch office of agency office 12. Agency office 12 is the head office, branch office 16 is a satellite office. As with agency office 12, branch office 16 will have management 52 accessing a computing device 54 and administration staff 56 accessing a computing device 58. Firewall 60 provides for secure communication over connection 26d to Internet 24.

Client home 18 allows an authorized user 62, be they a client or a family member to access client information via computing devices 64 or 66. Computing device 64 being connected to internet 24 via wired link 28e and computing device 66 connected to internet 24 via wireless link 28a. In use the devices 64 or 66 in client home 18 would allow a client or a family member to review the status of client care as stored by agency office 12, such as their Electronic Health Record (EHR), schedules of care and notes provided by the HCW.

Point of care 20 is utilized by either a personal support worker 68 or a HCW 70 to access information regarding the needs of the client from agency office 12 and to provide updates on the services provided. A personal support worker 68 typically provides non-medical related services such as cooking or house cleaning. A HCW 70 typically provides medical related services. As shown, personal support worker 68 may communicate with agency office 12 via link 28b through the use of a wireless device 72 such as a cell phone or personal data assistant. Similarly HCW 70 may communicate with agency office 12 via link 28c through the use of a wireless device 74. In addition wireless device 74 may be used when not connected to allow an HCW to enter data to be uploaded when a connection is established. Although a HCW and a personal support worker may have different tasks, for the purpose of simplifying the description of the embodiments of the invention they are generically referred to as HCW's.

Home office 22 illustrates how a HCW 76 through device 78 connected to agency office 12 via link 26f may access and update information in agency office 12 from their own home.

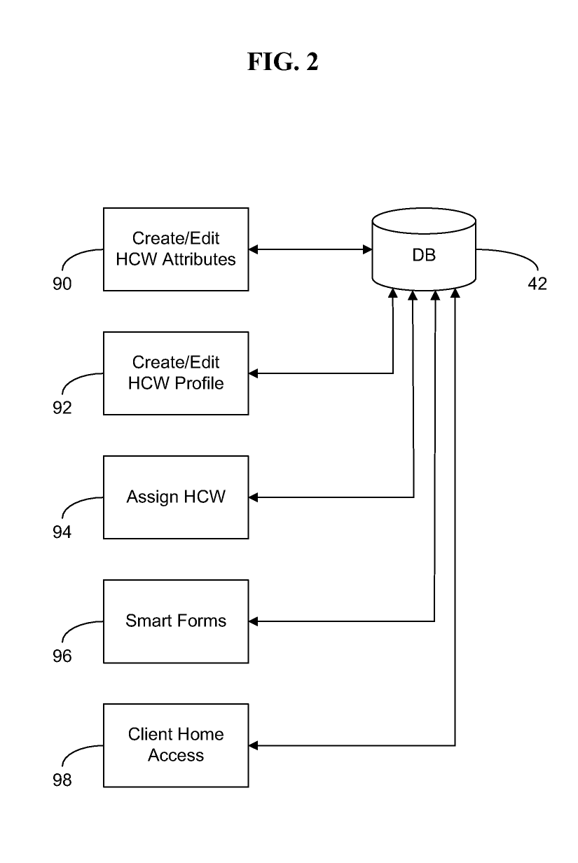

Referring now to FIG. 2, a block diagram of the components of an embodiment of the present invention is shown. Module 90 allows an administrator 38 (see FIG. 1) to create a number of attributes in database 42 to define what tasks a HCW is capable of, what professional qualifications they have and issues that may prevent a HCW from being assigned to a specific patient.

In the case of tasks a HCW is capable of they might include such attributes as:
a) can the HCW lift 50 pounds;
b) can the HCW cook and prepare meals; and
c) what languages can the HCW speak or read.

In the case of professional qualifications that a HCW may have might include such attributes as:
a) is the HCW a nurse;
b) is the HCW a physiotherapist;
c) is the HCW trained in wound management;
d does the HCW have CPR qualification;
e) does the HCW have first aid certification; and
f) is the HCW qualified for flu vaccination.

In the case of issues that may prevent a HCW from being assigned to a specific patient, these may include attributes such as:
a) is the HCW allergic to cats; and
b) is the HCW allergic to smoke.

As one skilled in the art and industry of home health care will appreciate any number of attributes may be stored in database 42 and edited by an administrator 38 or 56 through the use of module 90.

Module 92 allows an HCW (68, 70, 76) to create or edit a personal profile based on the attributes stored in database 42 by module 90. For each attribute the HCW answers in the positive or negative, with the ability to add qualifying information. For example the HCW may be a nurse, but not qualified to provide certain types of treatment without supervision.

Module 94 matches a HCW to a client based on a customer service order from a customer 14. Module 94 resides on server 30 for use by an administrator 38 or 56.

Module 96 allows an administrator 38 or 56 to create smart forms. Smart forms allow for the creation and reuse of forms to aid an agency in managing and reporting on work flow while providing data entry validation. A portion of module 96 also resides within devices 72, 74 and 78 to allow a HCW to utilize the smart forms.

Module 98 allows a client or family member to access health care information regarding the client as stored in database 42 from a computing device 64 or 66 accessible to the client or a family member.

All of components 90, 92, 94, 96 and 98 utilize data stored in database 42 to accomplish their tasks. As one skilled in the art will recognize database 42 need not be a single database and may be distributed as multiple databases shared by agency office 12 and branch office 16.

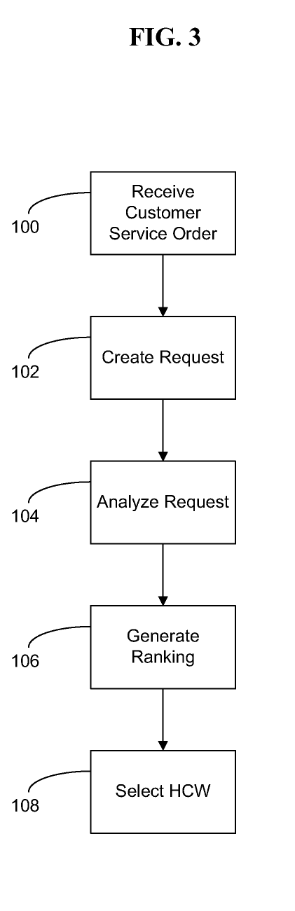

Referring now to FIG. 3 a flowchart of the process for assigning a HCW to a client is shown. The process shown in FIG. 3 resides in module 94 of FIG. 2. Beginning at step 100 a customer service order is received by agency office 12 from customer 14. Current practice is that the service order is provided via FAX but it may as well be provided via other electronic means such as email or an XML document prepared via a website. At step 102 an administrator 38 creates a request for a HCW based upon the attributes required in the service order. Although this step is currently implemented with human assistance, it could well be achieved by automated processing of an electronic service order that identifies the attributes required.

At step 102 a comparison is made based upon the attributes required with those of the HCW and other factors. This includes, but is not limited to:
a) The attributes required that were identified at step 102.
b) The ability to provide the service required, for example: nursing, physiotherapy, or occupational therapy.
c) The current workload of the HCW, can they handle a new task?
d) District, does the HCW reside in proximity to the client?
e) Language, does the HCW speak the desired language of the client?
f) Continuity, has the HCW seen the client before? It would be beneficial to establish visits from the same HCW.

At step 106 the results of step 104 are analyzed to generate a ranking of applicable HCW's to service the request. Each attribute and other factors are given a weighting be they all equal or a custom weighting of importance to the customer. For example continuity may be a major factor to a customer so it would weight higher than other factors. Other forms of custom weighting would take the form of certain terms, for example, “Do not provide any HCW's that cannot lift 50 pounds and do not speak Cantonese”.

At step 108 the HCW is selected based on the rankings. This may be done by an administrator or by the system automatically contacting the top ranking HCW via email or phone. If the top ranked HCW is not available, the next HCW would be contacted until a suitable HCW is found to be available.

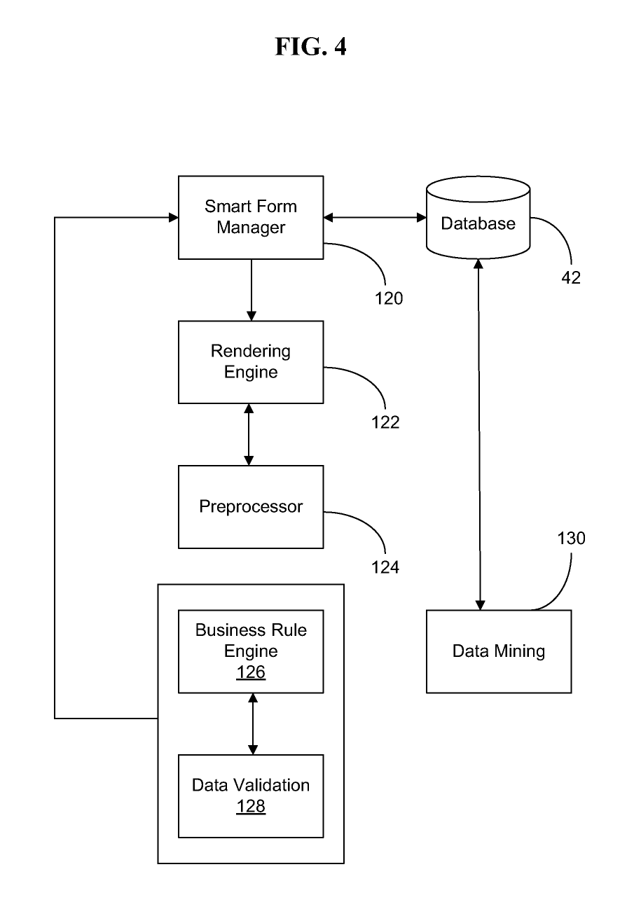

Referring now to FIG. 4 a block diagram of the components of the module implementing smart forms is shown. The components of FIG. 4 are those contained within module 96 of FIG. 2.

Smart forms refer generically to a component of the system that allows a user to manage dynamic forms. Smart forms allow for the creation and reuse of forms to aid an agency in managing and reporting on work flow while providing data and rule validation.

Smart form manager 120 provides a method for the user of smart form manager 120 to create, modify, delete and use a smart form. Smart form manager 120 provides means for the user to interact with the smart forms module in one of two modes. The first mode enables the user (an administrator) to define and edit a smart form and the second mode allows a subscriber (a HCW) to interact with the form. A subscriber enters data to complete a smart form but cannot modify, create or delete a smart form.

Rendering engine 122 resides on the system on which the smart form is to be displayed for data entry. This may be within computer 30 or devices accessed by a subscriber. Rendering engine 122 obtains information from smart form manager 120 to create a version of a form applicable for display on the user device.

Preprocessor 124 works with rendering engine 122 to provide a version of a form that contains default values for certain fields as provided in the smart form definition.

Business rule engine 126 works in conjunction with data validation module 128 to verify the form has been completed correctly. Data validation module 128 verifies that correct values have been entered in fields while business rules engine ensures that business rules that apply to a field are followed. These modules may reside within computer 30 or devices accessed by a subscriber.

Business rule engine 126 in addition to ensuring rules are followed during data entry also allows an administrator 38 to create and modify rules to be used for validating data input by users. Business rules are stored in database 42. In one embodiment rules are created using a scripting language such as VBScript or Javascript. A rule comprises two basic components, operands and operators.

Operands are objects or values used in calculations or comparisons, examples of which may be:
a) constants such as 4, 3.14159, True, null or Sunday.
b) class values that are available through the .NET run time package, such as the DateTime class;
c) field values from the database 42, such as a list of locations that are maintained in a table in the database 42; and
d) field values from the smart form, such as a drop down list created when a smart form is created.
   Operators combine operands and may consist of operators such as: addition, subtraction, division, multiplication, modulus and other mathematical functions.

Rules can be used to limit the values that may be entered in a data entry field. For example, a list of values indicating client satisfaction may be limited to: “Satisfied”, “Unsatisfied” and “Unknown”. Another example may be a requirement that a client age be between 0 and 150. Rules may also specify conditional operations, such as “If the client satisfaction is set to ‘Unsatisfied’ then data must be entered in a field providing a reason.”

In some cases rules may be dynamically generated without the need for them to be created by an administrator. Such an example would be in a data entry field requiring a health card number, the health card number may be checked for correctness without the need of a rule provided by an administrator.

Data mining module 130 is utilized by a management 34 or 54 to generate reports on data contained within database 42. For example a manager may want to predict a pandemic or determine statistical trending by geography or demographic. Data mining module 130 may make use of custom or specific queries to aid the agency in managing their business.

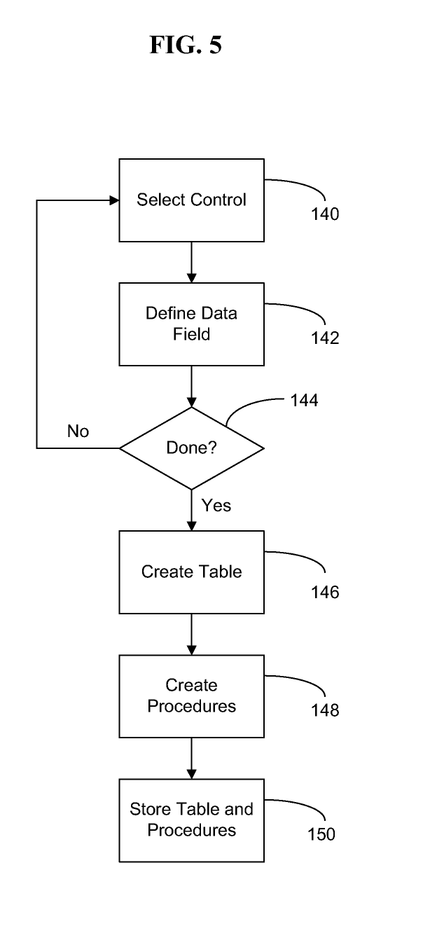

Referring now to FIG. 5 a flowchart of the process for creating or editing a smart form is shown. This process resides within smart form manager 120.

In creating or editing a smart form a user may construct a custom form in a visual manner, allowing the user to place graphical user interface controls on the form, and to define the layout of the form. In one embodiment the Microsoft .NET framework is utilized. Throughout the following description of this embodiment terms applicable to Microsoft .NET will be used. It is not the intent of the inventors to require that Microsoft .NET be utilized it serves simply as an example of a set of tools that may be used.

All .NET controls such as: Textbox, ComboBox, ListControl, Button, Date Selector and others may be utilized in creating a smart form. The selection of a control is made at step 140.

At step 142 the user may define a field as a data entry field. A data entry field may be assigned a default value, or a minimum and maximum range. A Label, LinkLabel, Textbox, ComboBox, MaskedTextbox, CheckBox, RadioButton, DateTime Picker, NumericUPDown, PictureBox, RichTextBox, ListBox, ListView, or TreeView placed on a smart form are examples of data entry fields. In addition such fields as ComboBox, ListBox, ListView and DataGridView may utilize a DataSource to pre-populate the field.

At step 144 a test is made to determine if the user has completed the form, if not processing returns to step 140. If the form has been completed processing moves to step 146.

At step 146 a table is generated in database 42 or perhaps a separate smart forms database within agency office 12 to represent the smart form. Each field in the form that is tagged as a data entry field is created as a column in the table representing the smart form. In addition the data type of each column is provided for each data entry field, as is the size of the data entry field and whether or not the data entry field is required. Further columns contain information such as: Created_by_id, Created_on, Modified_by_id; Modified_on and Is_deleted.

At step 148 procedures are also generated for manipulating the table data. These stored procedures support creating, reading, updating and deleting forms. The stored procedures are specific to each table as they need to be aware of the data elements in the table. The “create” stored procedure includes all columns of an existing table as parameters. The “read” stored procedure retrieves data for all columns of the table and any columns from relationship tables. The “update” stored procedure includes all columns of the smart form table as parameters. The “delete” stored procedure includes the record key and the user id forming the delete as parameters. The “create” and “update” stored procedures create an audit trail record in database 42 to record information on who created or updated a smart form and at what time.

At step 150 the newly created form an associated procedures are stored in database 42 or another forms specific database.

To further expand on the concept of pre-populating a field, when adding a data entry field to a form the user may select a table and a field from that table that will be tied to their input in order to pre-populate fields with existing data. This is done through the steps of:
a) Accessing the server 30 to determine the user's level of access;
b) Accessing the database 42 to determine the tables to which the user has access;
c) Populating a list of items with available table names to allow the user to select a table; and
   i) for each table, accessing the database 42 to determine the fields to which the user has access;
   ii) for each table, populating a list of fields to which the user has access; and
   iii) when the user selects a table to associate with a data entry field, presenting the list of accessible fields.
d) Saving the form with the association information to the appropriate table and field.

A user may also choose to disassociate a data entry field from another table and field. When this is done, the associated entries are removed from the table.

By way of an example of pre-populating fields with existing data, the database 42 has a table for “clients” which is linked to “service orders” which is in turn linked to “customer service orders” and in turn linked to “customers”. For a form that is based on a service order, available fields would be those in the service order table, as well as those in the customer service order, customer and client tables that are linked to the fields of the service order.

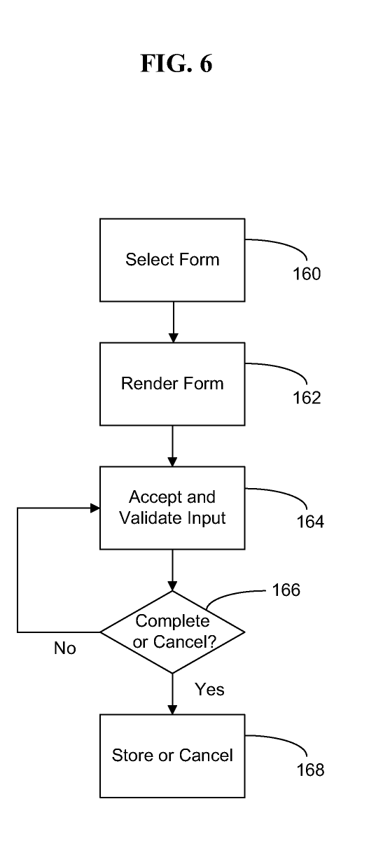

Referring now to FIG. 6 a flowchart of the process for a subscriber entering data for a smart form is shown.

Beginning at step 160 a subscriber chooses a form to complete. This request is handled by smart form manager 120.

Smart form manager 120 provides to rendering engine 122 at step 162 information needed to render a form for display to the subscriber. Rendering engine 122 resides on the system on which the smart form is to be displayed for data entry. This may be within computer 30 or devices accessed by a HWC. The smart form manager 120 provides to the rendering engine 122 an identifier that specifies the type of device that is being used to display the form. Examples of such computing devices would be a Personal Data Assistant, a BlackBerry (a trademark of Research in Motion Inc.), a cell phone, a tablet computer, a laptop computer or desktop computer.

At step 162 rendering engine 122 engages preprocessor 124 to create the desired form from database 42. Preprocessor 124 pre-populates the fields that are known. This is accomplished by the following steps:
a) Accessing the database 42 to determine which fields are associated with the selected smart form;
b) For each field, accessing the database 42 to determine the display order and positioning relative to other fields;
c) For each field, accessing the database 42 to determine the associated database table and database field; and
d) Determining the value that should be displayed in the data entry field prior to the user making any changes.

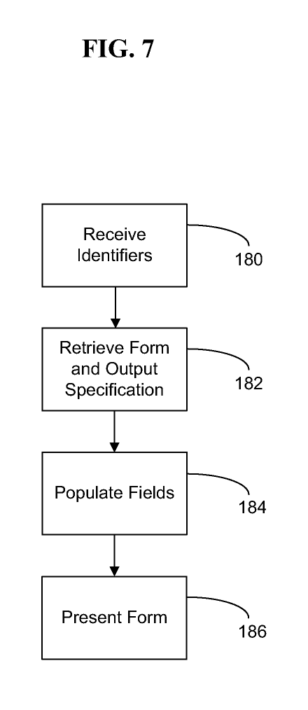

The output of preprocessor 124 is then returned to rendering engine 122. Utilizing the information provided by preprocessor 124, rendering engine 122 then checks database 42 for information specific to the device used by the subscriber and generates a form specific to that device. The function of rendering engine 122 is described in detail with reference to FIG. 7. The form is then provided to the subscriber at step 164 for the acceptation and validation of input.

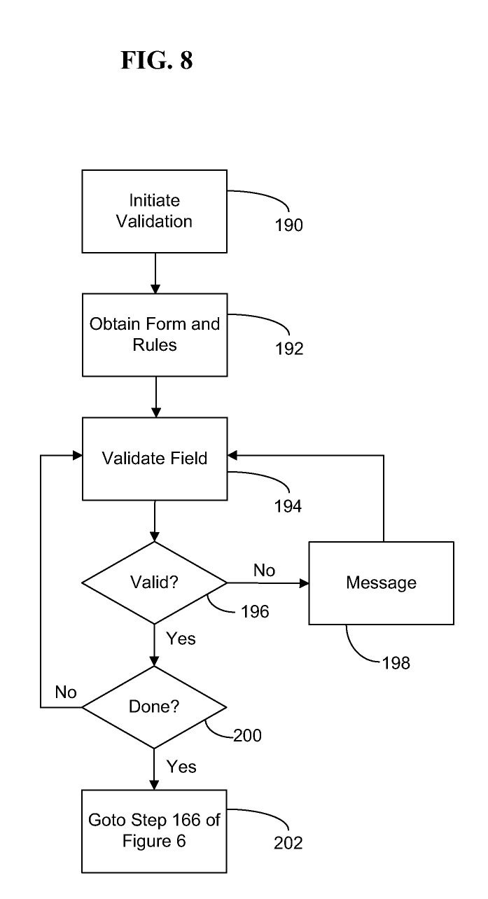

Validation of input is performed by business rules engine 126 and data validation module 128 which is described in detail with reference to FIG. 8.

At step 166 a test is made to determine if the user has completed the form or has decided to cancel data entry. If the user has neither completed data entry nor cancelled data entry, processing returns to step 164. If the user has completed data entry or has decided to cancel then processing moves to step 168. In the case of cancellation no information is stored in database 42. If the form has been completed the following information is stored in database 42;
a) current date and time stamp;
b) user identifier;
c) a form identifier indicating which form has been completed; and
d) for each data entry field on the form the value of that field is saved be it one created by the user or one created as a default by pre-populating the form.

Referring now to FIG. 7 a flowchart of the steps preformed by the rendering engine 122 is shown. Beginning at step 180 two identifiers are received from smart form manager 120. The first identifier indicates the form to be completed and the second identifier indicates the device the form is to be displayed upon.

At step 182 the first identifier is used to obtain from database 42 the form to be rendered and the second identifier is used to obtain the output specification for the form from database 42 that identifies the display capabilities of the device requesting the form. Display capabilities for any number of devices such as a BlackBerry, a Personal Data Assistant, a laptop computer, a tablet PC or a desktop PC may be stored for retrieval. Such information may include:
a) screen size of the device display;
b) resolution of the device display;
c) colour capabilities of the device display;
d) the type of document that will be rendered to the device, for example: Extensible Application Markup Language (XAML), Extensible Markup Language (XML), Extensible HyperText Markup Language (XHTML), HyperText Markup Language (HTML) or other formats including custom formats for a specific device.

At step 184 rendering engine 122 executes different logic for each document type required for the specific device to pre-populate the form. Each of these performs the following steps:
a) iterate through the fields that are to be pre-populated as specified in the smart form document;
b) for each field, utilize the document size and resolution to determine the next display location for the field; and
c) place the field at the calculated position and set the initial value of the field as the one specified by preprocessor 124.

When the iteration of step 184 is complete, the rendered form is presented to the subscriber at step 186.

Referring now to FIG. 8, a flowchart of the steps of data validation is shown. FIG. 8 describes in more detail step 164 of FIG. 6. Beginning at step 190 a rendered version of the form has been provided to the user and validation is initiated. Validation is a cooperative process between business rule engine 126 and data validation module 128.

Beginning at step 190 the user has the form provided to them on their device by rendering engine 122 and begins to complete the form. At this stage validation is initiated. This results in both business rule engine 126 and data validation module 128 becoming active. At step 192 data validation module 128 retrieves the definition of the form from database 42 along with the applicable business rules.

At step 194 as data is entered for each field the data is evaluated by data validation module 128 in real time. At step 196 if the data is invalid a message is sent to the user at step 198 and processing returns to step 194. The message generated at 198 may come from either the business rule engine 126 or the data validation module 128. A message from the business rule engine 126 may indicate that by providing a certain value in a field, additional fields need to be completed and may be optionally indicated as such on the form, for example by the use of an asterisk. A message from validation module 128 indicates that the value of a field is not correct.

If at step 196 the data is determined to be valid then processing moves to step 200 where a test is made to see if all fields have been completed. If not processing returns to step 194. If all fields have been completed, processing moves to step 202 where the data entry ends and control then returns to step 166 of FIG. 6.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Further the embodiments described herein may also be embodied in a computer readable medium for enabling a computing device to implement the systems and methods as defined by the claims.

Although embodiments of the invention as described and claimed refer to the specific job specialty of health care worker, one skilled in the art will recognize that creating attributes and profiles for individuals allowing for scheduling and the provision of smart forms for reporting may be applied to any number of business fields.

We claim:

1. A system for managing the assignment of and the reporting of health care workers, comprising:
a module configured to create and edit health care worker attributes;
a module configured to create and edit a health care worker profile based on said attributes;
a module configured to assign a health care worker to a client based upon said profile; and
a smart forms module configured to create forms for electronic presentation to said health care worker to record information on a client visit.

2. The system of claim 1 further comprising a module configured to allow client home access.

3. The system of claim 1 wherein said smart forms module further comprises:
a smart form manager configured to permit a user to design data entry forms;
a rendering engine configured to render said forms for display to a user;
a preprocessor operatively connected to said rendering engine and configured to preprocess said forms for said rendering engine;
a business rule engine and a data validation module configured to validate input provided by said user and provide a completed form to said smart form manager.

4. The system of claim 3 wherein said business rule engine is configured to create business rules.

5. The system of claim 1 further comprising a data mining module for the purpose of generating reports on client visits.

6. A method for managing the assignment of and the reporting of health care workers, comprising the steps of:
creating health care worker attributes;
creating a health care worker profile based on said attributes;
assigning a health care worker to a client based on said profile; and
electronically providing smart forms to said health care worker to record information on a client visit.

7. The method of claim 6 further comprising the step of providing a client home access to determine the status of visits to said client.

8. The method of claim 6 wherein said step of providing smart forms further comprises:
selecting a control for a field;
optionally designating said field as a data entry field;
creating a table describing a smart form based on the field definitions and storing said table in a database; and
creating procedures to act upon said table and storing said procedures in said database.

9. The method of claim 6 further comprising the step of permitting an administrator to create business rules for the completion of a smart form.

10. The method of claim 9 further comprising the step of utilizing said business rules to verify the data entered into said smart form.

11. The method of claim 6 further comprising the steps of utilizing a preprocessor and a rendering engine to display a smart form on a user device for completion by a user.

12. The method of claim 11 further comprising the step of said preprocessor pre-populating data entry fields on said smart form based upon the definition of said smart form and returning a preprocessed form to said rendering engine.

13. The method of claim 12 further comprising the step of said rendering engine modifying said preprocessed form to meet the display requirements for said user device.

14. The method of claim 6 further comprising the step of providing a data mining module to prepare reports on client visits.

15. The method of claim 6 wherein said step of assigning a health care worker is based upon a request received from a customer and matching said request to said attributes.

16. A computer readable medium containing instructions for executing the process of claim 6.
